(19) United States
(12) Patent Application Publication
(10) Pub. No.: US 2016/0134192 A1
(43) Pub. Date: May 12, 2016

(54) POWER SUPPLY SYSTEM

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: Ke-You HU, Shenzhen (CN)

(73) Assignee: HON HAI PRECISION INDUSTRY CO., LTD., New Taipei (TW)

(21) Appl. No.: 14/682,829

(22) Filed: Apr. 9, 2015

(30) Foreign Application Priority Data
Nov. 7, 2014 (CN) 201410622163.3

(51) Int. Cl. H02M 3/24

(52) U.S. Cl. CPC H02M 3/24

(57) ABSTRACT

A power supply system includes a rectifier circuit, a voltage decreasing circuit, and a feedback circuit. The rectifier circuit receives an AC voltage, and converts the AC voltage to a rectifying DC voltage. The voltage decreasing circuit decreases the rectifying DC voltage to a first DC voltage. The feedback circuit includes a photoelectric coupler, a PWM controller, a voltage regulating tube, and a variable resistor. The photoelectric coupler includes a light emitting unit and a switch unit. The variable resistor detects a change of the first DC voltage, and outputs a regulating signal. The voltage regulating tube adjusts a current flowing through the light emitting unit. The switch unit detects the light from the light emitting unit and turns on. The PWM controller outputs PWM signals to the voltage decreasing circuit. The voltage decreasing circuit adjusts the first DC voltage according to a duty cycle of the PWM signals.

### CROSS-REFERENCE TO RELATED APPLICATIONS

This application claims priority to Chinese Patent Application No. 201410622163.3 filed on Nov. 7, 2014, the contents of which are incorporated by reference herein.

### FIELD

The subject matter herein generally relates to a power supply system.

### BACKGROUND

Operational Amplifier (OP) is usually powered on by a direct current (DC) power supply. The DC power supply converts an alternating current (AC) voltage to a DC voltage which is provided to the OP. The DC power supply cannot regulate the DC voltage, which may cause the OP failure.

### BRIEF DESCRIPTION OF THE DRAWINGS

Implementations of the present technology will now be described, by way of example only, with reference to the attached figures.

FIG. 1 is a block diagram of an embodiment of a power supply system.

FIG. 2 is a circuit diagram of the power supply system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

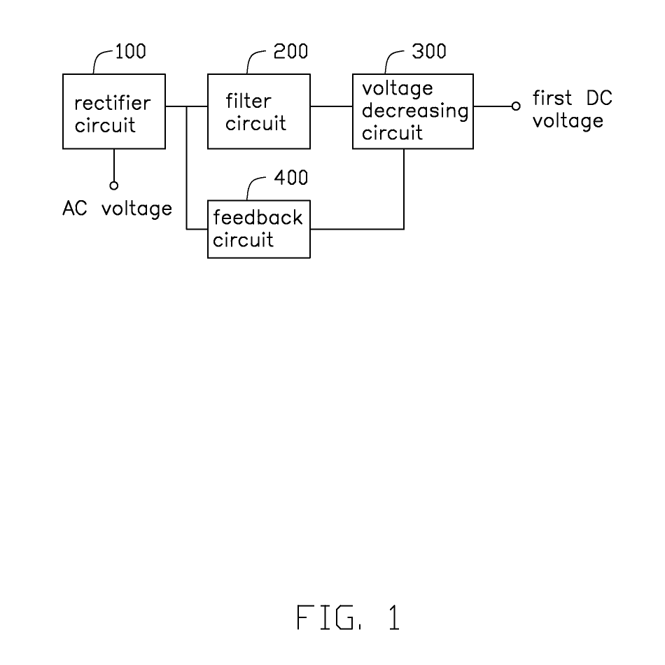

FIG. 1 illustrates a power supply system in accordance with one embodiment. The power supply system includes a rectifier circuit 100, a filter circuit 200, a voltage decreasing circuit 300, and a feedback circuit 400.

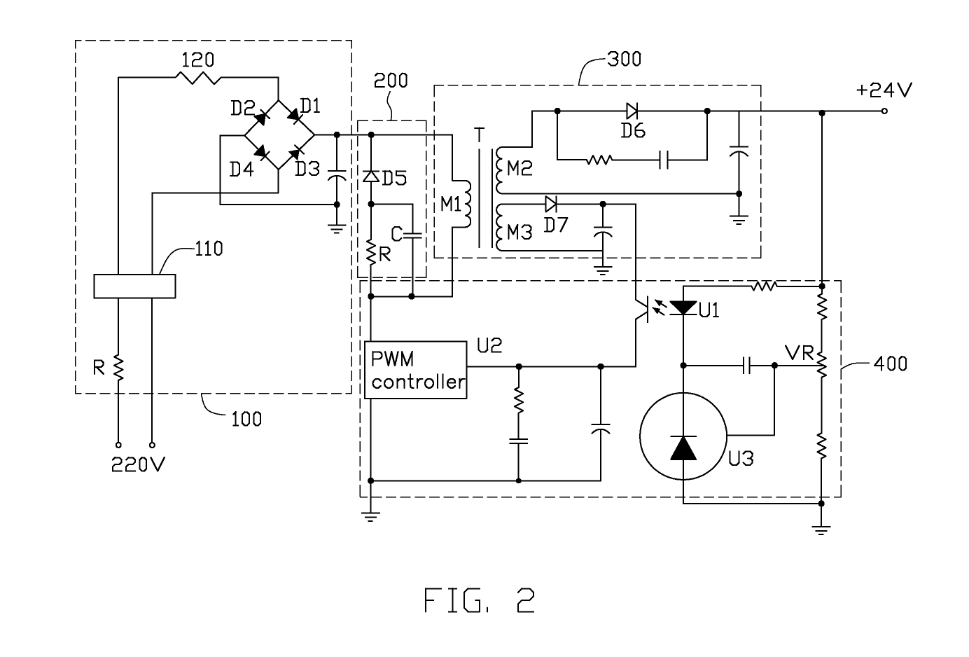

FIG. 2 illustrates that the rectifier circuit 100 includes a noise filter 110, a thermal resistor 120, a first diode D1, a second diode D2, a third diode D3, and a fourth diode D4. The noise filter 110 includes two input terminals and two output terminals.

The two input terminals of the noise filter 110 are configured to receive a 220 volts alternating current (AC) voltage. One output terminal of the noise filter 110 is electrically coupled to an anode of the first diode D1 and a cathode of the second diode D2 via the thermal resistor 120. Another output terminal of the noise filter 110 is electrically coupled to an anode of the third diode D3 and a cathode of the fourth diode D4. A cathode of the first diode D1 is electrically coupled to a cathode of the third diode D3. Anodes of the second diode D2 and the fourth diode D4 are grounded.

The filter circuit 200 includes a fifth diode D5, a resistor R, and a capacitor C. An anode of the fifth diode D5 is electrically coupled to the resistor R and the capacitor C. A cathode of the fifth diode D5 is electrically coupled to the cathodes of the first diode D1 and the third diode D3.

The voltage decreasing circuit 300 includes a transformer T, a sixth diode D6, and a seventh diode D7. The transformer T includes an input winding M1, a first output winding M2, and a second output winding M3.

A first terminal of the input winding M1 is electrically coupled to the cathode of the fifth diode D5. The anode of the fifth diode D5 is electrically coupled to a second terminal of the input winding M1 via the resistor R. The anode of the fifth diode D5 is electrically coupled to the second terminal of the input winding M1 via the capacitor C. A first terminal of the first output winding M2 is electrically coupled to an anode of the sixth diode D6. A cathode of the sixth diode D6 is configured to output a +24 volts first direct current (DC) voltage. A second terminal of the first output winding M2 is grounded. A first terminal of the second output winding M3 is electrically coupled to the feedback circuit 400 via the seventh diode D7. A second terminal of the second output winding M3 is grounded.

The feedback circuit 400 includes a photoelectric coupler U1, a pulse width modulation (PWM) controller U2, a voltage regulating tube U3, and a variable resistor VR. The photoelectric coupler U1 includes a light emitting unit and a switch unit.

A first terminal of the variable resistor VR is electrically coupled to the cathode of the sixth diode D6. A second terminal of the variable resistor VR is grounded. An adjusting terminal of the variable resistor VR is electrically coupled to a cathode of the voltage regulating tube U3 and an adjusting terminal of the voltage regulating tube U3. The cathode of the voltage regulating tube U3 is electrically coupled to a cathode of the light emitting unit. An anode of the light emitting unit is electrically coupled to the first terminal of the variable resistor VR. An anode of the voltage regulating tube U3 is grounded. An emitter of the switch unit is electrically coupled to a cathode of the seventh diode D7. An anode of the seventh diode D7 is electrically coupled to the first terminal of the second output winding M3. A collector of the switch unit is electrically coupled to a control terminal of the PWM controller U2. An output terminal of the PWM controller U2 is electrically coupled to the second terminal of the input winding M1.

In use, the rectifier circuit 100 converts the 220 volts AC voltage to a +220 volts DC voltage which is provided to the input winding M1 of the transformer T. The transformer T decreases the +220 volts DC voltage to a +24 volts first DC voltage which is output by the first output winding M2. The second output winding M3 of the transformer T outputs a second DC voltage. The anode of the light emitting unit receives the +24 volts first DC voltage. The light emitting unit emits light. The switch unit detects the light from the light emitting unit and turns on. The control terminal of the PWM controller U2 receives the second DC voltage from the second output winding M3. The output terminal of the PWM controller U2 outputs PWM signals according to the second DC voltage. The filter circuit 200 filters the PWM signals which are provided to the input winding M1. The input winding M1 adjusts the +220 volts DC voltage according to a duty cycle of the PWM signals. The first output winding M2 of the transformer T outputs a stable first DC voltage.

In at least one embodiment, the adjusting terminal of the variable resistor VR is adjusted to change a regulating parameter of the voltage regulating tube U3. A current flowing through the light emitting unit is changed. Strength of the light emitted by the light emitting unit is changed. The duty cycle of the PWM signals is changed to adjust the first DC voltage slightly.

When the first output winding M2 outputs an over current, a voltage on the variable resistor VR decreases. A current flowing through the adjusting terminal of the voltage regulating tube U3 decreases. The current flowing through the light emitting unit also decreases. The strength of the light emitted by the light emitting unit is weakened. The switch unit turns off. The PWM controller U2 cannot receive the second DC voltage from the second output winding M3. The PWM controller U2 stops working The output terminal of the PWM controller U2 stops outputting PWM signals. The first output winding M2 of the transformer T stops outputting the first DC voltage.

The embodiments shown and described above are only examples. Many details are often found in the art such as the other features of a power supply system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A power supply system comprising:
a rectifier circuit configured to receive an alternating current (AC) voltage, and convert the AC voltage to a rectifying direct current (DC) voltage;
a voltage decreasing circuit configured to receive the rectifying DC voltage, and decrease the rectifying DC voltage to a first DC voltage; and
a feedback circuit comprising:
a photoelectric coupler comprising a light emitting unit and a switch unit, the switch unit configured to be activated by detecting light from the light emitting unit;
a pulse width modulation (PWM) controller, the PWM controller outputting PWM signals to the voltage decreasing circuit;
a variable resistor configured to detect a change of the first DC voltage and configured to output a regulating signal, the voltage decreasing circuit configured to adjust the first DC voltage according to a duty cycle of the PWM signals; and
a voltage regulating tube configured to receive the regulating signal and configured to adjust a current flowing through the light emitting unit resulting in a change of strength of light emitted by the light emitting unit.

2. The power supply system of claim 1, further comprising a filter circuit; and the filter circuit filters the PWM signals which are provided to the voltage decreasing circuit.

3. The power supply system of claim 2, wherein the rectifier circuit comprises a noise filter, a thermal resistor, a first diode, a second diode, a third diode, and a fourth diode; the noise filter comprises two input terminals and two output terminals; the two input terminals of the noise filter are configured to receive the AC voltage; one output terminal of the noise filter is electrically coupled to an anode of the first diode and a cathode of the second diode via the thermal resistor; another output terminal of the noise filter is electrically coupled to an anode of the third diode and a cathode of the fourth diode; a cathode of the first diode is electrically coupled to a cathode of the third diode; and anodes of the second diode and the fourth diode are grounded.

4. The power supply system of claim 3, wherein the filter circuit comprises a fifth diode, a resistor, and a capacitor; an anode of the fifth diode is electrically coupled to the resistor and the capacitor; and a cathode of the fifth diode is electrically coupled to the cathodes of the first diode and the third diode.

5. The power supply system of claim 4, wherein the voltage decreasing circuit comprises a transformer, a sixth diode, and a seventh diode; the transformer comprises an input winding, a first output winding, and a second output winding; a first terminal of the input winding is electrically coupled to the cathode of the fifth diode; the anode of the fifth diode is electrically coupled to a second terminal of the input winding via the resistor; the anode of the fifth diode is electrically coupled to the second terminal of the input winding via the capacitor; a first terminal of the first output winding is electrically coupled to an anode of the sixth diode; a cathode of the sixth diode is configured to output the first DC voltage; a second terminal of the first output winding is grounded; a first terminal of the second output winding is electrically coupled to the feedback circuit via the seventh diode; and a second terminal of the second output winding is grounded.

6. The power supply system of claim 5, wherein a first terminal of the variable resistor is electrically coupled to the cathode of the sixth diode; a second terminal of the variable resistor is grounded; an adjusting terminal of the variable resistor is electrically coupled to a cathode of the voltage regulating tube and an adjusting terminal of the voltage regulating tube; the cathode of the voltage regulating tube is electrically coupled to a cathode of the light emitting unit; an anode of the light emitting unit is electrically coupled to the first terminal of the variable resistor; an anode of the voltage regulating tube is grounded; an emitter of the switch unit is electrically coupled to a cathode of the seventh diode; an anode of the seventh diode is electrically coupled to the first terminal of the second output winding; a collector of the switch unit is electrically coupled to a control terminal of the PWM controller; and an output terminal of the PWM controller is electrically coupled to the second terminal of the input winding.

7. The power supply system of claim 6, wherein the input winding of the transformer is configured to receive the rectifying DC voltage; and the transformer decreases the rectifying DC voltage to the first DC voltage which is output by the first output winding.

8. The power supply system of claim 7, wherein the second output winding of the transformer outputs a second DC voltage; the control terminal of the PWM controller receives the second DC voltage from the second output winding; and the output terminal of the PWM controller outputs PWM signals according to the second DC voltage.

9. The power supply system of claim 8, wherein the AC voltage is 220 volts; and the first DC voltage is +24 volts.

10. A power supply system comprising:
a rectifier circuit configured to receive an alternating current (AC) voltage, and convert the AC voltage to a rectifying direct current (DC) voltage;
a voltage decreasing circuit configured to receive the rectifying DC voltage, and decrease the rectifying DC voltage to a first DC voltage; the voltage decreasing circuit comprises a transformer; the transformer comprising:
an input winding configured to receive the rectifying DC voltage;
a first output winding configured to output the first DC voltage;
a second output winding configured to output a second DC voltage; and
a feedback circuit comprising:
a photoelectric coupler comprising a light emitting unit and a switch unit, the switch unit configured to be activated by detecting light from the light emitting unit;
a pulse width modulation (PWM) controller configured to receive the second DC voltage from the second output winding, and output PWM signals to the voltage decreasing circuit;
a variable resistor configured to detect a change of the first DC voltage and configured to output a regulating signal, the voltage decreasing circuit configured to adjust the first DC voltage according to a duty cycle of the PWM signals;
a voltage regulating tube configured to receive the regulating signal, and adjust a current flowing through the light emitting unit resulting in a change of strength of light emitted by the light emitting unit.

11. The power supply system of claim 10, further comprising a filter circuit; and the filter circuit filters the PWM signals which are provided to the voltage decreasing circuit.

12. The power supply system of claim 11, wherein the rectifier circuit comprises a noise filter, a thermal resistor, a first diode, a second diode, a third diode, and a fourth diode; the noise filter comprises two input terminals and two output terminals; the two input terminals of the noise filter are configured to receive the AC voltage; one output terminal of the noise filter is electrically coupled to an anode of the first diode and a cathode of the second diode via the thermal resistor; another output terminal of the noise filter is electrically coupled to an anode of the third diode and a cathode of the fourth diode; a cathode of the first diode is electrically coupled to a cathode of the third diode; and anodes of the second diode and the fourth diode are grounded.

13. The power supply system of claim 12, wherein the filter circuit comprises a fifth diode, a resistor, and a capacitor; an anode of the fifth diode is electrically coupled to the resistor and the capacitor; and a cathode of the fifth diode is electrically coupled to the cathodes of the first diode and the third diode.

14. The power supply system of claim 13, wherein the voltage decreasing circuit further comprises a sixth diode and a seventh diode; a first terminal of the input winding is electrically coupled to the cathode of the fifth diode; the anode of the fifth diode is electrically coupled to a second terminal of the input winding via the resistor; the anode of the fifth diode is electrically coupled to the second terminal of the input winding via the capacitor; a first terminal of the first output winding is electrically coupled to an anode of the sixth diode; a cathode of the sixth diode is configured to output the first DC voltage; a second terminal of the first output winding is grounded; a first terminal of the second output winding is electrically coupled to the feedback circuit via the seventh diode; and a second terminal of the second output winding is grounded.

15. The power supply system of claim 14, wherein a first terminal of the variable resistor is electrically coupled to the cathode of the sixth diode; a second terminal of the variable resistor is grounded; an adjusting terminal of the variable resistor is electrically coupled to a cathode of the voltage regulating tube and an adjusting terminal of the voltage regulating tube; the cathode of the voltage regulating tube is electrically coupled to a cathode of the light emitting unit; an anode of the light emitting unit is electrically coupled to the first terminal of the variable resistor; an anode of the voltage regulating tube is grounded; an emitter of the switch unit is electrically coupled to a cathode of the seventh diode; an anode of the seventh diode is electrically coupled to the first terminal of the second output winding; a collector of the switch unit is electrically coupled to a control terminal of the PWM controller; and an output terminal of the PWM controller is electrically coupled to the second terminal of the input winding.

16. The power supply system of claim 15, wherein the AC voltage is 220 volts; and the first DC voltage is +24 volts.
